(19) United States
(12) Patent Application Publication
(10) Pub. No.: US 2020/0195417 A1
(43) Pub. Date: Jun. 18, 2020

(54) CRYPTOGRAPHY CIRCUIT PARTICULARLY PROTECTED AGAINST INFORMATION-LEAK OBSERVATION ATTACKS BY THE CIPHERING THEREOF

(71) Applicant: INSTITUT MINES TELECOM, Palaiseau (FR)

(72) Inventors: Jean-Luc DANGER, ANTONY (FR); Sylvain GUILLEY, PARIS (FR)

(21) Appl. No.: 16/798,515

(22) Filed: Feb. 24, 2020

Related U.S. Application Data
(63) Continuation of application No. 13/145,181, filed on Aug. 3, 2011, now abandoned.

(30) Foreign Application Priority Data
Jan. 20, 2009 (FR) 0950342

(51) Int. Cl. H04L 9/00; H04L 9/06; G09C 1/00

(52) U.S. Cl. CPC H04L 9/003; H04L 9/0625; H04L 2209/046; H04L 2209/12; G09C 1/00

(57) ABSTRACT

A cryptography circuit, protected notably against information-leak observation attacks is provided. The cryptography circuit comprises a functional key k_{c} for executing a cryptography algorithm. It comprises a second key kᵢ unique and specific to the circuit making it possible to protect by masking the functional and confidential key k_{c} or a confidential implementation of the algorithm.

### CROSS-REFERENCE TO RELATED APPLICATIONS

This application is a continuation of U.S. patent application Ser. No. 13/145,181, filed Aug. 3, 2011, which is a National Stage of International patent application PCT/EP2010/050547, filed on Jan. 18, 2010, which claims priority to foreign French patent application No. FR 09 50342, filed on Jan. 20, 2009, the disclosures of which are incorporated by reference in their entirety.

### FIELD OF THE INVENTION

The present invention relates to a cryptography circuit, protected notably against information-leak observation attacks by their encryption.

### BACKGROUND

More and more communication and information processing systems are resorting to cryptographic methods to guard against any malicious exaction on the data which are required to travel over public media. In particular, encryption ensures the confidentiality of the data, cryptographic digest ensures their integrity and electronic signing ensures their authenticity. In each of these cases, a common secret is put into play between the party in charge of sending the data and the party in charge of receiving these data, these two parties possibly being one and the same. For an attacker hostile to these security mechanisms, that is to say wishing to illegitimately ascertain the content of a message, to modify the content of a transaction, to render impersonal or to deny the provenance of an exchange, a priority objective is to retrieve the common secret so as to benefit with impunity from powers similar to the authorized receiving party.

Direct attacks against cryptography algorithms have been and are still sometimes possible. Nonetheless, a continuous decrease in logical flaws is being observed. In particular, more and more cryptography algorithms are standardized after being passed through an international scrutiny test. This was notably the case for AES (Advanced Encrypton Standard) symmetric encryption at the end of the 1990's. The same scenario is currently unfurling for the future version 3 of the SHA secure hash algorithm.

However, with the increasing roamability of means for communication and information processing, new attacks are becoming conceivable. By observing the temporal behavior of a system, in terms of execution speed, its comprising electronics, in terms of energy consumption by a DPA attack for example, or its radiative behavior, in terms of magnetic radiation by an EMA attack for example, a great deal of information may leak. Protections against these attacks on the side channels have been proposed, on the basis notably:
of concealment, which involves rendering the leakage constant, in this instance independent of the secret;
of masking, which involves rendering the leakage random, that is to say unpredictable and therefore unexploitable.

These two techniques make it possible to increase the difficulty of attacks aimed at retrieving information, but they nonetheless remain vulnerable to attacks which would profit from implementational defects. Examples of DPA attacks are described in the document by P. Kocher et al: Differential Power Analysis, In proceedings of CRYPT'99, volume 1666 of LNCS, pages 338-397, Springer-Verlag, 1999. Examples of EMA attacks are described in the document by K. Gandolfi et al: Electromagnetic Analysis—Concrete Results, In CHES, volume 2162 of LNCS, pages 251-261, Springer-Verlag, 2001.

There exist numerous potential or substantiated examples of vulnerability. The following may notably be cited:
concealment based on differential logic (such as WDDL) may be vulnerable to an attack on differences in cumulative combinatorial lags between one or the other of the calculation phase, evaluation phase and precharge phase
the masking may be sensitive to high-order attacks, termed HO-DPA.

### SUMMARY OF THE INVENTION

An aim of the invention is notably to counter these attacks, notably of the DPA or EMA type. For this purpose, the subject of the invention is a cryptography circuit comprising a functional key k_{c} for executing a cryptography algorithm, characterized in that said circuit comprises a second key kᵢ independent of k_{c} and specific to each instance of said circuit, making it possible to protect the latter against attacks exploiting the side channels of the circuit.

This second key can either be stored in a dedicated storage unit or be specific to the component.

The functional key k_{c} is for example masked by the second key kᵢ by combining the two keys via the XOR operation, an input variable x being encrypted by the masked key k_{c}⊕kᵢ.

The second key kᵢ serves for example to protect the key k_{c} by virtue of a confidential implementation.

The second key kᵢ serves for example to protect a confidential algorithm, notably that comprising a standard cryptographic algorithm customized by the bracketing of two secret functions protected by masking with the key kᵢ.

The second key kᵢ is for example created by a function of the PUF (Physically Unclonable Function) or POK (Physically Obfuscated Key) type.

The second key kᵢ can also be programmed after fabrication of the circuit, by customization, with a unique random value in a secure enclosure.

The masking introduced by the second key kᵢ may be protected against HO-DPA high-order attacks.

The knowledge of the second key kᵢ, serving as implementation key unique to a circuit, allows for example the use of a protection control procedure to privileged users responsible for said control.

The may be realized on a programmable circuit of the FPGA type.

The second key kᵢ may be customized by way of an FPGA's programming file.

Advantageously, the circuit may be realized by a software implementation.

It comprises for example a third key k_{b} for encrypting the programming file (25) of said FPGA circuit, this conferring the confidentiality of the external storage and of the transfer of the key kᵢ to the FPGA.

The cardinal of the second key kᵢ is for example equal to the cardinal of the functional key k_{c}, this so as to render hidden-channel attack on kᵢ more difficult than cryptanalytic attack on k_{c}.

The cardinal of the cardinal of the third key k_{b} is greater than or equal to the cardinal of the functional key k_{c}.

The encryption algorithm is the DES algorithm.

### BRIEF DESCRIPTION OF THE DRAWINGS

Other characteristics and advantages of the invention will become apparent with the aid of the description which follows, given in relation to appended drawings which represent:

FIG. 1, an exemplary circuit comprising protection by masking of the key of the DES algorithm.

FIG. 2, the same circuit without masking.

FIG. 3, an example of pre-encoding added to the algorithm so as to protect an implementation by masking.

FIG. 4, an illustration of the principle of realizing a circuit according to the invention.

### DETAILED DESCRIPTION

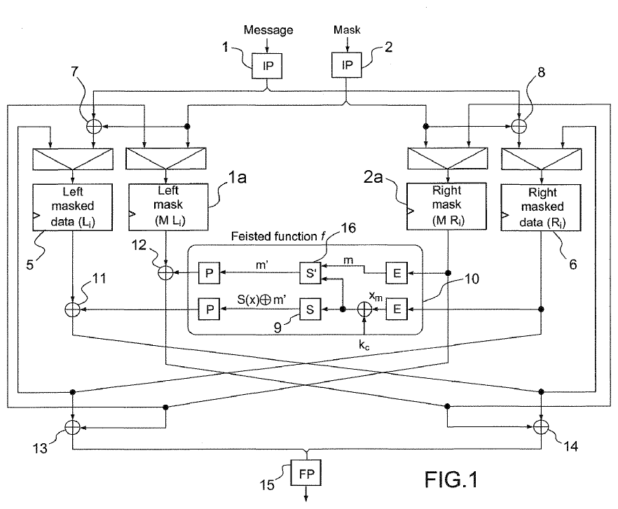

FIG. 1 presents a mode of masking to which the invention may be applied. More particularly, FIG. 1 presents by way of example an illustration of the masking of the DES (Data Encryption Standard) algorithm implemented notably according to the architecture overviewed in the document by S. Guilley et al: A fast Pipelined MultiMode DES Architecture Operating in IP Representation, Integration, The VLSI Journal, 40(4) pages 479-489, July 2007, DOI. The circuit of FIG. 1 is for example realized in a programmable logic circuit of FPGA (Field Programmable Gate Array) type. In this algorithm, the data path is split into two parts, left and right.

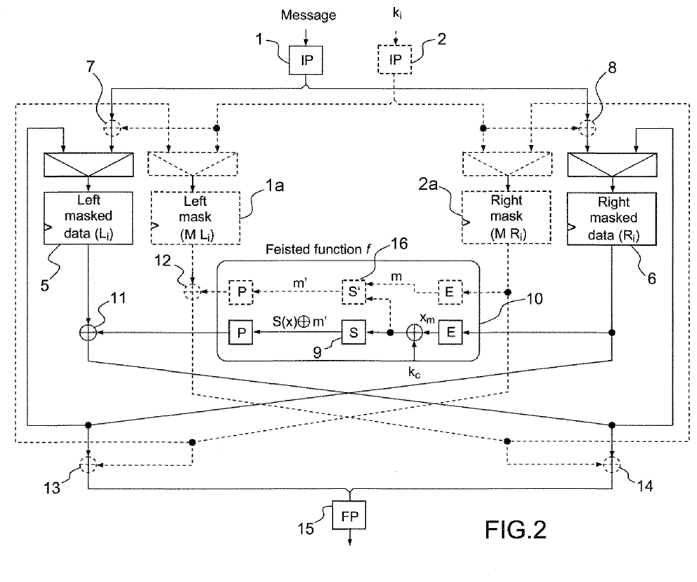

By way of comparison FIG. 2 represents the same circuit highlighting the hardware overhead for ensuring protection by masking, the circuits giving rise to this overhead being indicated by dashed lines.

An input message 1 is therefore apportioned between a left data register and a right data register. A mask 2 is apportioned between a left mask register 5 and a right mask register 6. Before being stored in the left and right data registers, the data of the message are masked by combining with the mask data by means of an XOR gate 7 on the left and of an XOR gate 8 on the right. The encryption key, k, is also masked by the mask m by a Feistel function 10. The masked datum of the right register 6 and the half-mask of the right register 2a form the inputs of the Feistel function wherein the right masked datum is encrypted by a first substitution box 9 and where the right half-mask is encrypted by a second substitution box 16. The data of the left data register 5 and left mask register 1a are combined respectively with the right datum and with the new mask, at the output of the Feistel function, by means of XOR gates 11, 12 and are thereafter looped back to the right registers, the right and left data being subsequently recombined by XOR gates 13, 14 so as to output 15 the encrypted message. In a circuit of the type of FIG. 1, only the data registers 5, 6 are assumed to leak.

A circuit according to the invention preserves the leak but renders it encrypted, therefore incomprehensible. Thus an attacker carrying out for example an attack of DPA or EMA type finds only the variable:

K⊕M (1)

that is to say the secret key K itself encrypted by a mask M. This mode of protection of the key K is known by the name of Vernam encryption, with the “exclusive or” operation, also called XOR, and denoted by ⊕, a Vernam code being a code that can be encrypted with the XOR operation. A cryptography circuit according to the invention is therefore protected against attacks on the hidden channels by Vernam encryption of information leaks.

There exist application fields where the encryption algorithm is completely customized. Such is the case for example in the public or private sphere for GSM or pay-per-view television which rely on confidential cryptography. An argument customarily put forward to justify this choice is that attacks on the side channels, so-called SCA (Side-Channel Attacks), are impossible since the leakage function to be correlated with the circuit is unknown. In the document K. Tiri et al: Side-Channel Leakage Tolerant Architectures, In ITNG'06—Proceedings of the Third International Conference on Information Technology, New Generation, pages 204-209, Washington D.C., USA, 2006 IEEE Computer Society, it is proposed to modify at one and the same time the implementation and the functionality of an algorithm, with or without overhead in terms of quantity of hardware. A drawback of the previous two procedures is that the encryption becomes functionally secret. This may be admissible in certain typical cases when security professionals implement the system and its deployment. But in the great majority of cases, when the design and the distribution of the encrypting systems is difficult to monitor, this scenario is very uncertain. Once the functionality of the secret has been recovered, an attack of the DPA type becomes possible again in a trivial manner. Moreover certain certification policies, such as for example FIPS-140, demand the non-customized use of cryptography standards, this rendering all the SCA-tolerant procedures advocated, notably in the document by K. Tiri et al, prohibitive.

According to the invention, to carry out an encryption, while complying fully notably with the known functional specification of this encryption, a protection by masking is performed using a mask specific to the cryptography circuit to be protected. A circuit according to the invention comprises a masking architecture where the mask M, specific to the circuit, is simply constant and unknown to the user or to the designer of the circuit.

It may be demonstrated that a masking path according to FIG. 1 does indeed carry out a Vernam encryption of the cryptographic key in accordance with equation (1) hereinabove, within the framework of a first-order DPA attack, that is to say an attack where only the data registers 5, 6 are assumed to leak. Moreover, any variant around the masking can also be used to implement the invention: it suffices in fact that the implementation be expressed differently from the reference implementation while preserving the functionality. In the case of the masking, the reference implementation corresponds to that with a zero mask (everything zero); but as soon as the mask is nonzero, the implementation changes, without however modifying the functionality. Now, it is also possible to change representation so as to introduce variability into the implementation. For example, in “A New DPA Countermeasure Based on Permutation Tables. In SCN, volume 5229 of Lecture Notes in Computer Science, pages 278-292. Springer”, Jean-Sebastian CORON proposes to modify the elementary operation parts of the AES with the introduction of 2 bijections 4-bit→4-bit, in such a way, however, that by assembling them, they do indeed give the calculation of a conventional AES. This change of representation can also give rise to a secret implementation, the information leakage of which is, however, not studied in this document.

Thus, first-order correlation attacks are rendered impossible since the leakage model is unknown. Moreover, attacks which rely on the construction of a set, or catalog, of measurements, such as so-called “template” attacks, are also rendered infeasible since each implementation being unique, it is impossible to construct a universal catalog.

Advantageously, with the invention, the diversity of the implementations is comparable, or indeed equal, to the number of cryptographic keys. In particular, an attack of “second preimage” type is then impossible. The probability of finding by chance a circuit whose key is programmable having the same mask as a circuit in active service is comparable, or indeed equal, to the probability of guessing the right key by chance, that is to say of succeeding with an exhaustive search on the key by brute force attack.

In the example of FIG. 1, the hardware added in order to implement the masking is formed of the left 1a and right 2a mask registers and of the XOR gates 12, 13, 14 combining the masks with the data as well as of the substitution circuits 16 of the Feistel function processing the output of the right mask register.

Within the framework of an ASIC or FPGA based realization, the masking of other types of cryptographic primitives may be automated with the assistance of suitable CAD tools operating directly on the source code.

It is interesting to note that the protection procedure can be applied generally to any implementation which contains a secret that might leak via a side channel. An immediate example is the protection of encryption keys, but signature keys are equally well protected in the same way. Moreover, instead of protecting a parameter of a cryptographic algorithm, it is also possible to protect the algorithm itself, if it is confidential. This happens in sectors such as pay-per-view television, where a non-interoperable cryptography may be implemented since the communications are encrypted point-to-point (satellite toward decoder). It is then usual to use a standardized algorithm while modifying one or more elements therein (such as the substitution tables or the diffusion functions). In this way, customization of the algorithm is achieved without running the risk of weakening its security.

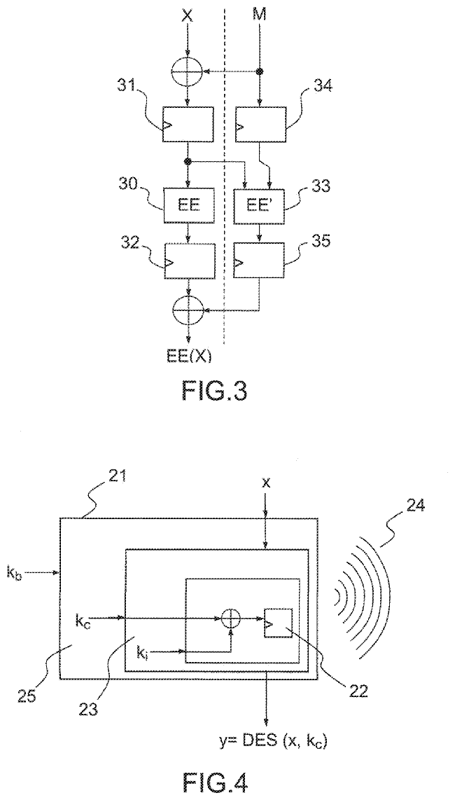

FIG. 3 illustrates another way of proceeding. In this example, a standard algorithm A is reused as is, but to bracket it with external encodings (EEin and EEout), so that the function carried out is no longer A, but the composition EEout ∘ A ∘ EEin. An explanation of this principle is given in the introduction to the article by C. Clavier: Secret External Encodings Do Not Prevent Transient Fault Analysis, in CHES'07, volume 4727 of Lecture Notes in Computer Science, pages 181-194. The left part 30, 31, 32 of FIG. 3 shows how a masking technique can prevent the values EE(X) from leaking, the function EE 30 being bracketed by two registers 31, 32 where the first register 31 receives the datum x⊕m. The function EE′ 33 disposed in parallel, defined as EE′(a,b).=EE(a)⊕EE(a⊕b), ensures that demasking remains possible. Thus, by virtue of the addition of the hardware 33, 34, 35 represented in the right part of FIG. 3, none of the registers contains EE(x), whatever the input X to the algorithm. In this way, it is impossible to backtrack to an arbitrary item of information about the secret external encoding EE. Hereinafter, without however losing generality, concentration is placed on the typical case of the protection against leakage of a cryptographic key.

A solution of the FPGA type advantageously allows each circuit to have its own configuration, even during large-scale deployment. In particular with an FPGA solution, it is needless to recompile a whole system in order to modify a value, such as the mask specific to a component notably, in order to customize it. This implies that Kerckhoffs' principle is not violated, each implementation being actually secret, but unique. The compromising of an implementation does not allow the compromising of all the setups.

The retro-design of the functionality of certain FPGA circuits may be made possible on account of the fact that it is programmed software-wise, in a file situated in a permanently readable memory. To avoid such a retro-design, it is possible to use a type of FPGA making it possible to encrypt this file, termed “bitstream”. Thus, the protection is itself kept confidential by cryptographic means. Code obfuscation is an additional parry to complicate the operation aimed at backtracking from machine language to a high-level specification.

FIG. 4 illustrates in a schematic and simplified manner an exemplary circuit according to the invention. This circuit 21, of FPGA type, involves three keys.

A functional key k_{c} serves to implement the encryption in the circuit 21. This encryption is for example the DES algorithm 23 which transforms an input variable x into an enciphered variable y=DES (x, k_{c}) inside a register 22.

A non-functional key kᵢ serves to mask the functional key k_{c}. It is this key kᵢ which forms the mask M of the functional key, an XOR operator combines these two keys into k_{c}⊕kᵢ. The key kᵢ therefore serves to protect the functional key k_{C} of the DES implementation against information leaks 24, by observation of magnetic radiation or of instantaneous consumption notably.

Another non-functional key k_{b} serves to protect the secret elements of the “bitstream” file 25, that is to say at least kᵢ, or indeed k_{c}.

Preferably, in this scheme, the keys are dimensioned in such a way that:

|kᵢ|=|k_{c}| (2)

and |k_{b}|≥|k_{c}| (3)

|kᵢ|, |k_{b}|, |k_{c}| expressing respectively the cardinal of kᵢ, of k_{b} and of k_{c}.

According to the invention the implementation of the cryptography algorithm 23 is such that the enciphered variable Y is functionally independent of the key kᵢ protecting the encryption key k_{c} of the variable, the information leaks of the setup being as diverse as 2^{|k}^{ᵢ}^{|} (2 to the power |kᵢ|).

In the case of a DES algorithm, y=DES (x, k_{c}, kᵢ) with y functionally independent of kᵢ.

It should be noted that a first-order attack is not simply rendered more difficult but impossible. Since it is necessary to guess k_{c} knowing k_{c}⊕kᵢ, kᵢ being totally unknown, including to a user or to a designer. In this, the invention affords a high degree of confidence, security being proven against any adversary having a calculation force of less than 2^{|k}^{ᵢ}^{|}. This amounts to the security level of the DES algorithm itself when |kᵢ|=|k_{c}|.

It is possible to use a function of PUF (Physically Unclonable Functions) or POK (Physically Obfuscated Key) type, (i.e. implementation-specific physical key), or any other system making it possible to generate a secret specific to the circuit 21 instead of a key supplied from outside, via a public-key infrastructure, termed PKI, or any other mechanism for customizing confidence.

The second key kᵢ can still be programmed after fabrication of the circuit with a single random value in a secure enclosure.

It is also possible to use a masking mechanism with constant mask, which moreover uses counter-measures to attacks on the combinatorial logic, also known by the name “Shallow Attack”, or against HO-DPA attacks.

It should be noted that an attack on the algorithmic masking exploiting the presence of non-functional transitions, also called “glitches”, hardly dependent in the secret mask, such as presented notably in the document by S. Mangard et al: Successfully Attacking Masked AES Hardware Implementations, In LNCS, editor, Proceedings of CHES'05, volume 3659 of LNCS, pages 157-171, Springer, September 2005, Edinburgh, Scotland, does not apply to a secret implementation, since it is impossible to carry out a simulation of the circuit, not knowing it. In fact, this attack relies on a correlation with a pre-characterized model. This step is infeasible with a circuit according to the invention, except for a possible clued-up attacker who would know the design of the masks of the ASIC produced, or the “bitstream” file of the FPGA, or who would have a sample where the mask can be chosen. To prevent this possibility, the PUF function described previously can notably be used.

Certain proprietary algorithms, in particular the standard algorithms encapsulated between two secret encodings, are not resistant to perturbation attacks as shown notably in the document by C. Clavier: Secret External Encodings Do Not Prevent Transient Fault Analysis, In CHES, volume 4727 of Lecture Notes in Computer Science, pages 181-194, Springer, 2007. This class of attack requires that the attacker be able to fix the value of a register at a known value, such as 0x00 for example. In a circuit protected by an implementation key kᵢ according to the invention, this is very difficult in practice if the data register and mask register are disjoint, since the attacker would then have to achieve multiple faults that are much more difficult to generate than simple faults.

A type of protection according to the invention, with implementation key kᵢ, can advantageously be combined with other protections such as for example the usual protections for detecting faults, at the RTL level in respect of coding, or the physical level in respect of encapsulation. This makes it possible to attain a high level of protection both against passive attacks and against active attacks.

1. A cryptography circuit comprising a functional key k_{c} for executing a cryptography algorithm,
said circuit comprising a second key kᵢ, wherein said second key is specific to each instance of said circuit, allowing said circuit to be protected against attacks using the auxiliary channels of said circuit, said functional key k_{c} being masked by said second key kᵢ by combining the two keys using the XOR operation, an input variable x being encrypted by the masked key k_{c}⊕kᵢ, with ⊕ designating the XOR operator, and
said second key being created by a Physically Unclonable Function or PUF.

2. The circuit according to claim 1, wherein the masking that is introduced by said second key kᵢ is protected against higher order attacks (HO-DPA) by a constant masking.

3. The circuit according to claim 1, wherein said circuit is produced on a programmable circuit of the FPGA type.

4. The circuit according to claim 3, wherein said circuit comprises a third key kₛ for encrypting the programming file of said FPGA circuit, the latter conferring the confidentiality of the external storage and of the transfer of the key kᵢ to the FPGA circuit.

5. The circuit according to claim 1, wherein the cardinal of said second key kᵢ is equal to the cardinal of said functional key k_{c}.

6. The circuit according to any one of claim 4, wherein the cardinal of said third key kₛ is greater than or equal to the cardinal of said functional key k_{c}.

7. The circuit according to claim 1, wherein the encryption algorithm is the DES algorithm.
